(19) United States
(12) Patent Application Publication
(10) Pub. No.: US 2015/0106425 A1
(43) Pub. Date: Apr. 16, 2015

(54) Performance Optimization in a Secured Computing Environment

(71) Applicant: International Business Machines Corporation, Armonk, NY (US)

(72) Inventor: David Hadas, Zichron Yaakov (IL)

(73) Assignee: International Business Machines Corporation, Armonk, NY (US)

(21) Appl. No.: 14/050,375

(22) Filed: Oct. 10, 2013

(51) Int. Cl. H04L 29/06

(52) U.S. Cl. CPC H04L 67/42
USPC 709/203

(57) ABSTRACT

Machines, systems and methods for servicing requests, the method comprising: receiving a first client request from a client system in a communications network, wherein the first client request is to be serviced by a first request processor process running on a server system connected to the communications network; identifying a first channel, wherein the first request processor process is configured to service requests delivered via the first channel; determining whether the server system is ready to deliver client requests to the first request processor process via the first channel; in response to determining that the server system is ready, delivering the first client request to the first channel; and in response to determining that the server system is not ready, creating the first channel, delivering the first client request to the first channel and configuring the first request processor process to service requests delivered via the first channel.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to optimizing the servicing of requests in a secured computing environment and, more particularly, to a system and method for improving performance of a service with measures for securely processing requests from different users.

### BACKGROUND

In a multi-tenant computing network, a web server may be implemented to receive requests that are to be processed by one or more request processor processes running on a physical network node. Different request processor processes may be used for performing different subsets of tasks or to perform a given task on behalf of different users or tenants. The request processor processes may be specific to a particular tenant When a request associated with a given task, user and tenant arrives, a request processor process assigned to perform that task for the particular user and tenant handles the request.

To submit a request to be processed by a certain request processor process, a handler process communicates with the request processor process using inter-process communication such as a socket or a pipe. For example, the request processor process may create a particular socket or a pipe that is known also to other handler processes that need to submit requests to the particular request processor process. Different request processor processes serving different subset of requests may use different sockets or pipes.

For example, a Unix domain socket or other functional equivalents may be used to create one or more sockets or pipes or other inter- process communication means. In a Unix domain, a socket is associated with a particular name in a directory tree such that different sockets use different names For successful communication over a socket, a handler process and the request processor process are needed to indicate the name of the socket and to perform the necessary tasks to establish an inter-process communication mean.

In order for the handler process to send a request to a particular request processor process, the handler process needs to (a) open a client-side socket for the particular named socket for writing, and (b) send the request by writing the request to a client-side socket. In order for a particular request processor process to serve requests sent to a particular named socket, the request processor process needs to (a) open a server-side socket for the particular named socket for reading, and (b) read and serve any request sent by the handler process to the particular named socket. Note that multiple instances of handlers may open the client-side named socket and write to the socket concurrently.

A handler process may be implemented on the web server that receives the incoming requests and determines to which request processor process the request is to be submitted for processing. Typically, if the particular request processor process (e.g., a process associated with the specific task, user id and tenant id) is not running, then its associated server-side socket is not open. In this scenario, the handler process would fail to open the client-side of the named socket. In other words, if a handler tries to open a particular client-side named socket prior to a request processor opening the server-side of the same named socket, the handler would fail to open the client-side socket.

After the handler has detected that the appropriate request processor is not running, the handler may either abort the request or else it would need to trigger the initiation of the particular request processor process. For example, the handler process may ask a moderator process (or other system) to instantiate the particular request processor process for servicing the particular tenant's request. Then the handler process would need to repeatedly try to submit the particular request until the particular request processor process is initialized and fully running. That is, during the time that it takes for the request processor process to create the necessary server-side socket for the particular named socket, the handler process must wait and resubmit the request.

The above submit and wait scenario also known as “busy waiting” is wasteful because the request processor process initialization is asynchronous to the handler process and the handler has no alternative but to retry the request until it becomes successful. Substantial overhead and expense may be associated with having to wait and resubmit the requests, especially when considering the possibility for a large volume of requests arriving at different handlers to be served by the same or different request processor processes for the same or different tenants on the same physical node.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, machines, systems and methods for servicing requests in a computing environment are provided. The method comprises receiving a first client request from a client system in a communications network, wherein the first client request is to be serviced by a first request processor process running on a server system connected to the communications network; identifying a first channel, wherein the first request processor process is configured to service requests delivered via the first channel; determining whether the server system is ready to deliver client requests to the first request processor process via the first channel; in response to determining that the server system is ready, delivering the first client request to the first channel; and in response to determining that the server system is not ready, creating the first channel, delivering the first client request to the first channel and configuring the first request processor process to service requests delivered via the first channel.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates an exemplary computing environment in accordance with one or more embodiments, wherein a handler process communicates with a request processor process to service a plurality of requests.

FIG. 2 is a block diagram of an exemplary computing environment in which a handler process initiates a server-side socket, in accordance with one embodiment.

FIG. 3 is a flow diagram of an exemplary method for optimizing the servicing of requests in accordance with one embodiment by way of the handler process initiating a server-side socket.

FIGS. 4A and 4B are block diagrams of hardware and software environments in which the disclosed systems and methods may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

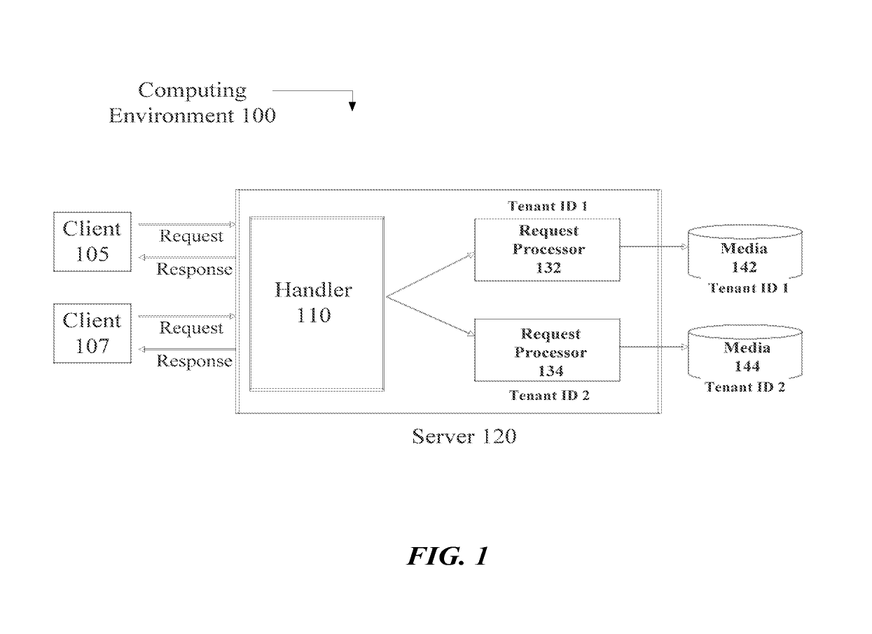

Referring to FIG. 1, in a multi-tenant computing environment 100, requests submitted by clients 105 and 107 to server 120 are analyzed by instances of a handler 110 which decides which request processor out of request processor should process each request. Request processor processes (e.g., request processors 132, 134) execute with limited privileges to perform tasks on behalf of clients 105 and 107. As such, data belonging to client 107 remains inaccessible to tasks or processes designated for servicing requests submitted by client 105. In one implementation, a unique tenant ID assigned to client 105 is used by handler process 110 to forward the request to request processor 132, so that client 105's data stored on one or more media (e.g., media 142) is accessible via the associated tenant ID (e.g., tenant ID 1), while data belonging to another client such as client 107 (e.g., media 144) remains inaccessible.

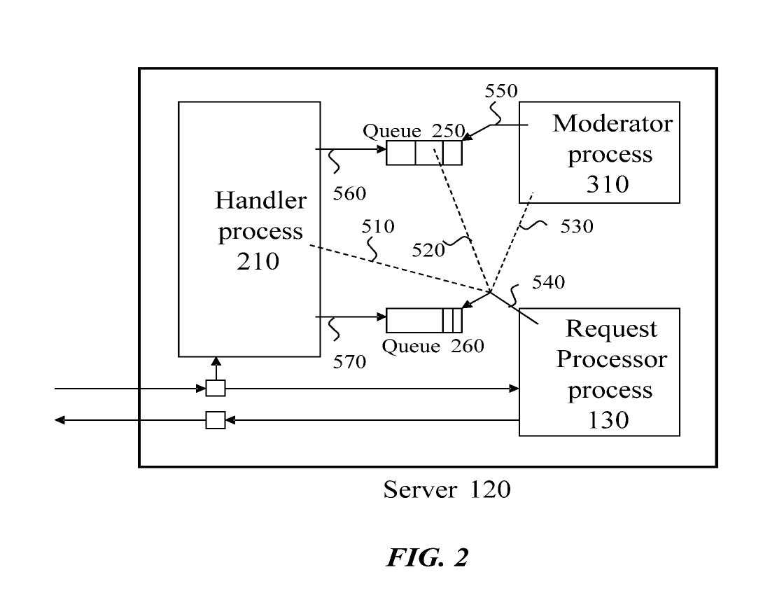

Referring to FIG. 2, a handler process 210 may analyze an incoming request and identify that the request should be processed by a request processor process 130 while request processor process 130 may not be running at the time. Handler process 210 may therefore need to request moderator process 310 to initiate request processor process 130. In accordance with one or more embodiments, the processing of requests communicated from handler process 210 to request processor process 130 in a multi-tenant computing environment may be optimized by transferring the responsibility for initiating a server-side socket of a particular named socket to the handler process 210.

This may be accomplished by handler process 210 mapping the request to a request processor process 130 and the particular named socket used by request processor process 130. Handler process 210 may thus avoid busy waiting (i.e., a delay associated with having to wait for request processor process 130 to initialize and open a server-side socket) by creating the server-side socket on behalf of request processor process 130. In this manner, handler process 210 may forward the request to the socket prior to request processor process 130 initializing. After creating the server-side socket, handler process 210 may ask moderator process 310 to initiate request processor process 130 with the server-side socket created by handler process 210.

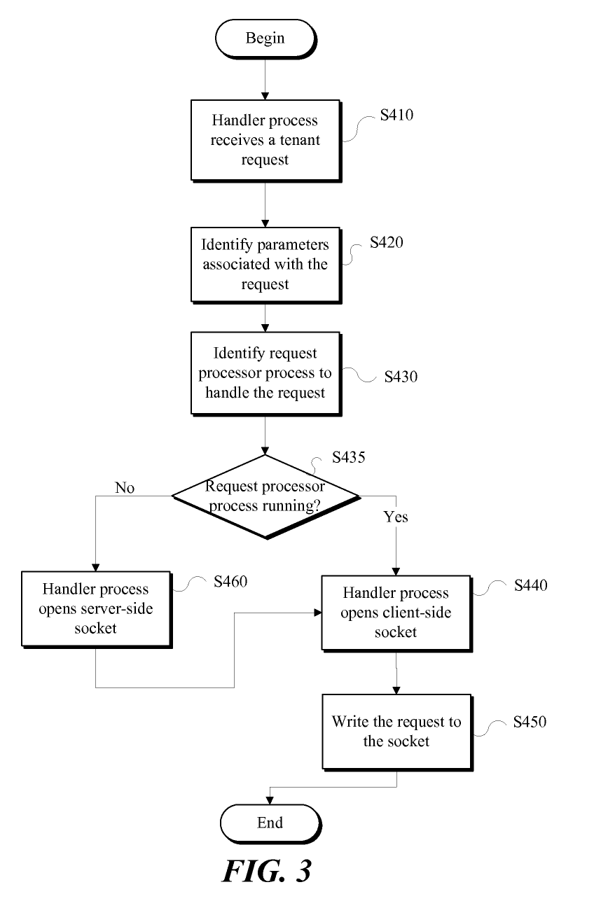

Referring to FIG. 3, once the handler process 210 receives a tenant request (S410), the handler process 210 identifies one or more parameters (e.g., session ID, request ID, user ID, tenant ID, etc.) associated with the request (S420). Based on the one or more parameters, handler process 210 identifies the request processor process 130 that is going to be servicing the request (430) and its associated named socket. To successfully service the request, the request processor process 130 identified for servicing the request needs to be running Accordingly, in one embodiment, it is determined whether the identified request processor process 130 is running or else that the associated named socket exists (S435), preferably before submitting the request to be processed by the request processor process 130.

In one implementation, the handler process determines if the particular request processor process is running by the handler opening a client-side socket of the named socket and sending the request to the client-side socket. If this operation fails, it is determined that the server-side socket of the named socket is not opened and that the request processor process cannot accept requests. If so, that is an indication that the identified request processor process is not running In one embodiment, the handler process 210 may use other ways to check if the particular request processor process 130 is running.

If it is determined that the request processor process 130 is running or else that the associated named socket exists, unless already opened in a previous stage, the handler process 210 opens a client-side socket for the named socket which serves as the inter-process communication channel associated with the request processor process 130 (S440) and submits the request to the identified request processor process 130 by way of sending (e.g., writing) the request to the named socket (S450). In one embodiment, the handler process 210 determines the named socket associated with the request processor process 130 based on the task name and the tenant ID (TName, TID), such that the name used to form the named socket has a one-to-one mapping to the combination (TName, TID). The request processor process 130 may asynchronously read the request via a server-side socket for the named socket and process the request.

If it is determined that the request processor process 130 is not running, or else that the associated named socket does not exists, then the handler process 210 opens a server-side socket for named socket (S460) which may later serve as the inter-process communication channel to request processor process 130. Handler process 210 may open the server-side socket on behalf of the identified request processor process 130. For example, to open a Unix domain socket, the handler process 210 may open the named socket for reading. Once the server-side socket is opened and initialized, the handler process 210 opens a client-side socket of the particular named socket for writing (S440) and sends the request to the request processor process 130 by writing it to the named socket (S450), as if the request processor process 130 is already running Depending on implementation, the request may be stored in a queue within the inter-process communication channel, for example, queue 260 of FIG. 2, until request processor process 130 is initiated and running

The handler process 210 may request for the identified request processor process 130 to be instantiated and use the server-side socket, opened by the handler process 210, to receive the request and any other requests sent by other handler processes to the named socket. The submitted request or requests by the handler process 210 (and optionally other handler processes) to the particular named socket may be queued in a data storage medium (e.g., a memory area managed by the operating system) until the identified request processor process 130 is instantiated and running. As the request processor process 130 is initialized, it uses the server-side named socket created by handler process 210 instead of creating its own. In this way, request processor process 130 may read requests sent by handler process 110 and other handlers.

Referring back to FIG. 2, handler process 210 may first try to address an existing request processor process 130 by addressing the inter-process communication channel shown as queue 260. If such named socket exists, the request is sent to queue 260 using a client side socket (570) and later read by the request processor process 130 using a server side socket (540). If request processor process 130 is not running and respectively the inter-process communication channel (e.g., queue 260) does not exist, handler 110 may create the inter-process communication channel for example by opening a server side pipe or socket (510) and then send a handler to the inter-process communication channel to moderator process 310.

In one embodiment, handler process 110 may use a separate inter-process communication channel (shown as queue 250) to communicate with moderator process 310. The message sent by handler process 110 to moderator process 310 may include a handle or a file descriptor pointing queue 250 (520). In this manner, moderator process 310 gains a handle or file descriptor to queue 250 (530) which may now be delivered to the request processor process 130 (540). Moderator process 310 may, for example, spawn a child process that would serve as request processor process 130 using a fork( ) instruction or other process spawning method, thus initiating the request processor process 130 and delivering the file descriptor (540) to the respective request processor process.

In one embodiment, moderator process 310 may be implemented to change roles to become a request processor and service the queued requests directly. Using the above implementation, the handler process 210 no longer has the burden or overhead associated with having to wait and continually submit requests to a request processor process that is not yet running, during the time it takes for the request processor process to be instantiated or created. Instead, the requests are stored in a queue 260 and later serviced when the request processor process is ready. A file descriptor to queue 260 is delivered to the request processor process 130, for example via queue 250 and later during a fork or exec instruction. To deliver the file descriptor via queue 250, the moderator process 310 may open a server-side named socket (550) for the named socket shown as queue 250, and the handler process 210 may open a client-side socket (e.g., client-side socket 560) to the same named socket (queue 260).

It is noteworthy that, in one embodiment, handler process 210 may initiate the request processor process 130 directly using fork and exec instructions, for example. Alternatively, handler process 210 may become the request processor process 130 by changing its role. The role change may be accomplished by, for example, using an exec instruction. Further, the handler-created server-side socket may be represented in some operating systems as a file descriptor (e.g., a Unix operating system file descriptor) which is transferred from the handler process 210, or optionally another process (e.g., a moderator process 310 to the request processor process 130 by way of a fork( ) instruction. The file descriptor identifying the socket may be then passed to a child process of the moderator or handler processes by way of a fork or an exec instruction.

References in this specification to “an embodiment”, “one embodiment”, “one or more embodiments” or the like, mean that the particular element, feature, structure or characteristic being described is included in at least one embodiment of the disclosed subject matter. Occurrences of such phrases in this specification should not be particularly construed as referring to the same embodiment, nor should such phrases be interpreted as referring to embodiments that are mutually exclusive with respect to the discussed features or elements.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

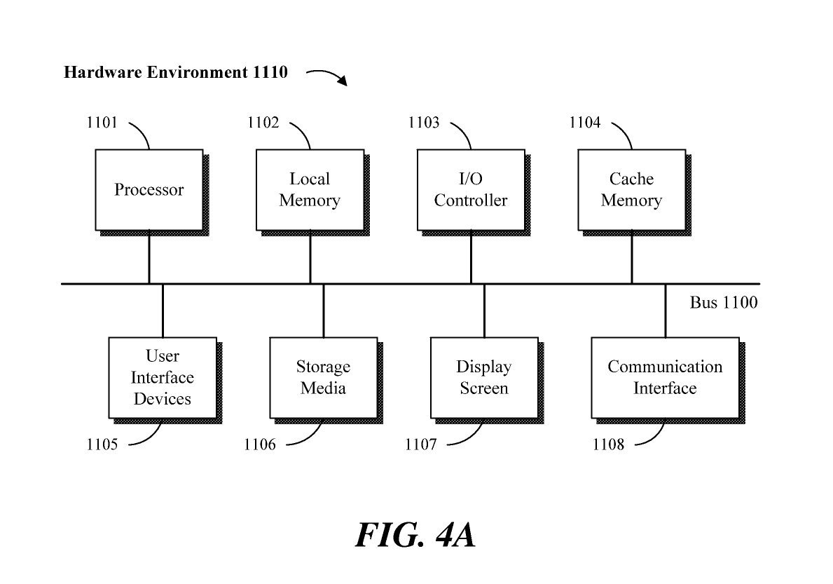

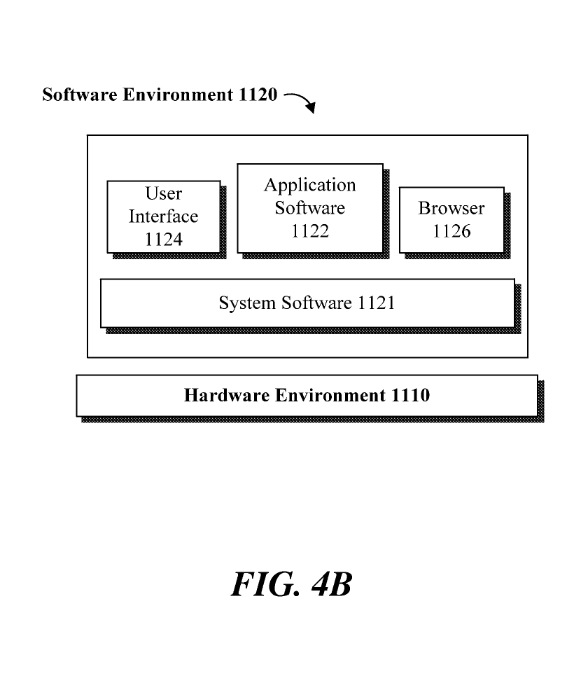

Referring to FIGS. 4A and 4B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 4A, the application software and logic code disclosed herein may be implemented in the form of machine readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 4B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a machine-usable or computer readable storage medium that provides program code for use by, or in connection with, a machine, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, can be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions.

It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A method for servicing requests in a computing environment, the method comprising:
receiving a first client request from a client system in a communications network, wherein the first client request is to be serviced by a first request processor process running on a server system connected to the communications network;
identifying a first channel, wherein the first request processor process is configured to service requests delivered via the first channel;
determining whether the server system is ready to deliver client requests to the first request processor process via the first channel;
in response to determining that the server system is ready, delivering the first client request to the first channel; and
in response to determining that the server system is not ready, creating the first channel, delivering the first client request to the first channel and configuring the first request processor process to service requests delivered via the first channel.

2. The method of claim 1, wherein the first channel comprises at least one of an inter-process communication channel, a socket, a pipe, a socket with a well known address, or other addressable communication means for transmitting data between processes running in the computing environment.

3. The method of claim 1 wherein the first channel is created by opening at least one of a socket or a pipe for reading data written to the channel.

4. The method of claim 3 wherein servicing of the first client request delivered via the first channel is achieved by reading the data written to the first channel.

5. The method of claim 4, wherein delivering of the first client request to the first channel is achieved by opening at least one of a socket or a pipe for writing data to the first channel.

6. The method of claim 1, wherein the server system is determined to be ready, in response to determining that the first channel exists or that the first request processor process is running on the server system.

7. The method of claim 1, wherein in response to determining that the server system is not ready, the first request processor process is initiated, executed and configured to service requests delivered via the first channel to the server system.

8. The method of claim 1, wherein a handler process is executed on the server system for receiving the first client request and creating the first channel, in response to determining that the server system is not ready.

9. The method of claim 8, wherein the first request processor process is configured to service requests delivered via the first channel by the handler process transferring a handle of the first channel to the first request processor process,
wherein the handle is indirectly transferred via one or more moderators, wherein the one or more moderators comprise at least one of an operating system kernel or other processes in the computing environment.

10. The method of claim 1, wherein the first request processor process and the corresponding first channel are identified as associated with the first client request based on one or more parameters associated with the first client request.

11. The method of claim 10, wherein the one or more parameters comprise at least one of session ID, request ID, request type, user ID, or tenant ID.

12. The method of claim 1, wherein the first request processor process is configured to service requests delivered via the first channel on the server system through use of a moderator process, the method comprising;
transferring a request to the moderator process to initiate and execute the first request processor process and a handle to the first channel;
wherein the moderator process initiates and executes the first request processor process and provides the first request processor process with the handle to the first channel;
wherein the handle is used by the first request processor process to service requests delivered via the first channel.

13. The method of claim 12, wherein the moderator process initiates the request processor process as a child process of the moderator process and passes to the child process the handle to the first channel.

14. The method of claim 1, wherein the computing environment serves multiple tenants, wherein different request processor processes are used for servicing different tenant requests such that:
the first client request includes at least a tenant ID, and
the tenant ID is used to identify the first channel.

15. A system for servicing requests in a computing environment, the method comprising:
a logic unit for receiving a first client request from a client system in a communications network, wherein the first client request is to be serviced by a first request processor process running on a server system connected to the communications network;
a logic unit for identifying a first channel, wherein the first request processor process is configured to service requests delivered via the first channel;
a logic unit for determining whether the server system is ready to deliver client requests to the first request processor process via the first channel;
wherein in response to determining that the server system is ready, the first client request is delivered to the first channel; and
wherein in response to determining that the server system is not ready, the first channel is created, the first client request is delivered to the first channel and the first request processor process services requests delivered via the first channel.

16. The system of claim 15, wherein the first channel comprises at least one of an inter-process communication channel, a socket, a pipe, a socket with a well known address, or other addressable communication means for transmitting data between processes running in the computing environment.

17. The system of claim 15 wherein the first channel is created by opening at least one of a socket or a pipe for reading data written to the channel.

18. A product comprising a data storage medium with logic code embedded thereon , wherein execution of the logic code on a computing system causes the computing system to:
receive a first client request from a client system in a communications network, wherein the first client request is to be serviced by a first request processor process running on a server system connected to the communications network;
identify a first channel, wherein the first request processor process is configured to service requests delivered via the first channel;
determine whether the server system is ready to deliver client requests to the first request processor process via the first channel;
in response to determining that the server system is ready, deliver the first client request to the first channel; and
in response to determining that the server system is not ready, create the first channel, deliver the first client request to the first channel and configur the first request processor process to service requests delivered via the first channel.

19. The product of claim 18, wherein the first channel comprises at least one of an inter-process communication channel, a socket, a pipe, a socket with a well known address, or other addressable communication means for transmitting data between processes running in the computing environment.

20. The product of claim 18 wherein the first channel is created by opening at least one of a socket or a pipe for reading data written to the channel.
